(19) United States
(12) Patent Application Publication
(10) Pub. No.: US 2015/0287146 A1
(43) Pub. Date: Oct. 8, 2015

(54) Profile Critique System For Online Dating And Social Networking Websites

(71) Applicant: Antoine El Daher, Kenmore, WA (US)

(72) Inventor: Antoine El Daher, Kenmore, WA (US)

(21) Appl. No.: 14/244,904

(22) Filed: Apr. 4, 2014

(51) Int. Cl. G06Q 50/00; G06Q 30/00

(52) U.S. Cl. CPC G06Q 50/01; G06Q 30/00

(57) ABSTRACT

A method for allowing users on social networking websites, online dating websites, business networking websites, or other profile-based websites to request critiques for their profile, that they can use to improve their profile. In its main embodiment, a user submits a request to the server for profile feedback, further specifying the characteristics of the users that he wishes to get feedback from. For example, on an online dating website, a male user might want profile critiques to be done by female users within his age range, whereas on a business networking website, a user might want critiques from people with more work experience. The targeted users are then notified that a user wants to have their profile reviewed, and given the opportunity to submit either textual or numeric feedback about how to improve the profile. The reviews submitted by those users are then shown to the requesting users, though they can be restricted to be anonymous and private, and can even be restricted to be obtained from reviewers who are located a great distance away from the requesting user.

### BACKGROUND

### Prior Art

The following is a tabulation of some prior art that presently appears relevant to this application:

### U.S. Patents and Applications

| Pat. No. | Issue Date | First Patentee or Assignee |
|---|---|---|
| 6,480,885 | Nov. 12, 2002 | Michael Olivier |
| 7,454,357 | Nov. 18, 2008 | Eharmony, Inc. |
| 7,669,123 | Aug. 11, 2006 | Facebook, Inc. |
| 7,725,492 | May 25, 2006 | Facebook, Inc. |
| 7,917,448 | Mar. 29, 2011 | Yahoo! Inc. |
| 8,060,463 | Nov. 15, 2011 | Amazon Technologies, Inc. |
| 8,566,327 | Oct. 22, 2013 | Choi |
| 8,583,563 | Nov. 12, 2013 | Carrico |
| 20050021750 | Jan. 27, 2005 | Friendster Inc., |
| | | A California Corporation |
| 20060059147 | Mar. 16, 2006 | Yahoo! Inc. |
| 20060085419 | Apr. 20, 2006 | Rosen James S |
| 20060106780 | May 18, 2006 | Ofer Dagan |
| 20060173963 | Aug. 3, 2006 | Microsoft Corporation |
| 20070073687 | Mar. 29, 2007 | Match.Com, L.P. |
| 20070073803 | Mar. 7, 2007 | Match.Com, L.P. |
| 20070192106 | Aug. 16, 2007 | Signal Match Inc. |
| 20080294624 | Nov. 27, 2008 | Ontogenix, Inc. |
| 20080301118 | Dec. 4, 2008 | Shu-Yao Chien |
| 20090106043 | Mar. 23, 2009 | Eharmony, Inc. |
| 20100293476 | Nov. 18, 2010 | Radius Dating LLC |

Over the past few years, the Internet has seen a rise in the number of websites available. One type of such websites are online dating and social networking websites. These websites are designed to allow human users to post information about themselves, in what is called a profile. The profile typically contains one or more traits that the user has. Such traits include but are not limited to: age, gender, pictures of the user, and possibly profession, work experience and physical address. We interchangeably refer to those user traits hereafter as characteristics or properties. Those profiles can serve a variety of purposes: in online dating, the profiles give other users of the website a general idea of what the user looks like and allows those other people to decide whether they think the user would be a good romantic match for them. In social networking, the profile is put up to allow friends and family to see it, and let them keep in touch with the user through e-mail, messaging, or other means. In business online networks, the profile can serve as a resume to allow other professionals, recruiters or companies to evaluate the user and potentially consider him as a candidate for a job opening.

In nearly all of the situations described above, the human user creates a page that he believes will best portray him in the online community that he joined, and allow him to achieve certain goals: for example, finding a romantic partner in online dating, getting a job offer in business networks, and so on. There are several other situations where websites are advertising users' profiles, and several websites where the users are the main product of the website. With the rise of social networking, these websites are becoming more and more dominant.

One issue that a lot of users seem to suffer from is creating high-quality profiles that can actually allow them to achieve their goals. For example, in an online business networking site, the user may create the best profile that he thinks he can make based on his experience, but a recruiter or someone with hiring experience might look at it and think it is lacking in quality. Recruiters and hiring managers in this example have a much better understanding of what makes a profile desirable to their company, and can provide valuable advice to the original user about modifications to make. Typically, an inexperienced job applicant will try to look for a friend who is more experienced than him, and have him review his profile in order to emphasize the more important and valuable points therein.

In online dating, a user may take pictures and write a profile of himself thinking it is good, only to be found bad by the people he is trying to romantically connect to—unfortunately in such cases, the other party seldom communicates to the user the reason for the rejection, making improvement more difficult. What he'll typically do then is have someone else review his profile and get feedback about how he can improve it.

The prior art is currently such that there are several such social networking and online dating networks, and their users are typically allowed to rate or make personal notes about other users' profiles either positively or negatively, but such feedback is typically not shared with the target users and more importantly, cannot be used by the target user to improve their own profile.

We use the words critique, feedback and reviews interchangeably throughout the text to mean the act of one user A looking at a second user B's profile, and A giving user B information about how A believes that B can improve his profile to better help him reach his target audience. A critique can be numeric such as a grading system associated with a question, textual or both. For example, a piece of critique information on a business site that user A could give about user B, could be: “Your educational experience looks good but you haven't emphasized any of the extra-curricular activities you've done. I think those would add value to your profile”.

We use the word website to denote the set of all links contained within the same internet web domain. For example foo.com is a website associated with the URL http://foo.com/user1 or with URL http://mail.foo.com/otherlink/somethingelse.

### SUMMARY

This summary is meant to introduce a few concepts in a simplified form that are further described below in the Detailed Description. It is not intended to identify key features or essential features of the claimed subject matter, nor is it intended to be used as an aid in determining the scope of the claimed subject matter.

The premise of this application is that for social networking websites, online dating sites, business networking websites, it would be useful if there was a reliable way to get quality profile reviews and critiques from other members.

One embodiment for solving this problem follows: we propose a method by which a user can request feedback about his user profile from within the website in which his profile is located. The user can target what kinds of other users he would like to get feedback from. This targeting may include gender, age, professional experience, physical location, as well as other factors that are typically available in users' profiles. The targeted users are then either notified that a profile needs reviewing, or can be shown the profile when they decide to do reviews. The reviews submitted by those users can be restricted to be anonymous and private, and can even be restricted to be obtained from reviewers who are located a great distance away from the requesting user.

We describe several other embodiments in the detailed description and claims.

### Advantages

The advantages of such a system is that it allows users to get the most out of their profile by having it vetted by other users of the site who may have more experience or who may be better than the original user at improving its quality.

### DRAWINGS

FIG. 1 is a flow diagram that illustrates a method for obtaining profile critiques for a user from a set of users within the same website.

FIG. 2 shows a second proposed embodiment, as a flow diagram that illustrates a method for anonymously obtaining profile critiques for a user from a set of anonymous users within the same website.

FIG. 3 shows a third proposed embodiment, which illustrates a method for obtaining profile critiques from a set of users without directly messaging them.

FIG. 4 describes a basic social networking architecture as they are currently available on the market.

FIG. 5A shows part of the contents of one of the terminals used in FIG. 4.

FIG. 5B shows part of the contents of one of the servers used in FIG. 4.

### DETAILED DESCRIPTION

### First Embodiment

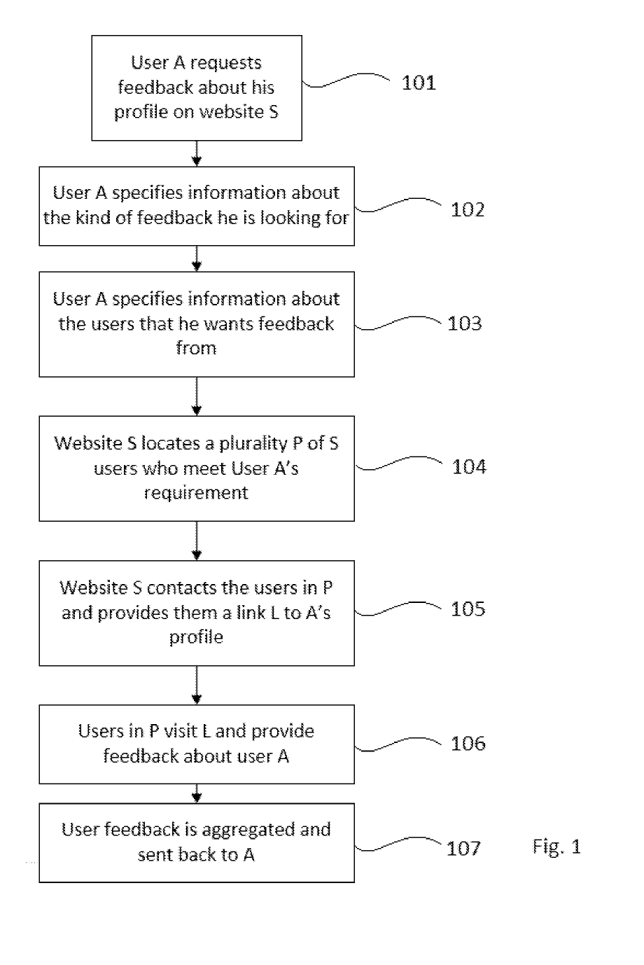

FIG. 1 shows a flow diagram that illustrates a method for obtaining profile critiques for a user from a set of user in the same website.

In the first step 101, the user A takes an action to request feedback about his profile on website W. In this embodiment, the action is to click a link on the website that indicates that user A is interested in having critiques for his profile. This request is stored on a database in the website server of website W, as detailed below.

User A is then taken to step 102 in the website, where he can specify to the website the kind of feedback about his profile that he is looking for. In this context, kinds of feedback means what part of his profile does user A want reviewed, and what he is hoping to achieve. Examples of those kinds of feedback are: photo feedback, i.e. feedback about whether his photos look good, and how he can improve them, or whether to deleted them; profile feedback, i.e. feedback about the overall profile, whether it subjectively fits together; text feedback, i.e. feedback about any textual paragraphs that user A has written in his profile are subjectively well written and promote him as he expects. The kinds of feedback are certainly not limited to those listed above, and could include several alternatives which are too numerous to list here: more examples include professional experience feedback, professional objective feedback, feedback about A's advertised professional skills, and so on. The data that user A provides is then stored on the website database.

From here on, user A is taken to step 103 where user A can specify the kinds of users that he would like to receive feedback from on the website. It should be mentioned that the order of 102 and 103 is not strict, and that a user may take step 103 before or at the same time as step 102. In particular 103 asks the user to specify parameters about the target reviewers: such parameters include, but are not limited to age, gender, professional experience, personal experience, how long the users have been on the website, physical location and so on. The website provides a form for the user to fill where he can specify zero or more such restrictions on the target reviewers, and those restrictions are stored on the website database. This is what is meant as the “kinds of users” in the definition above.

At this point, in step 104, website W's server, which comprises one or more computer-readable media storing computer-useable instructions that can be used by one or more computing devices, will search through its database to find a plurality of users or at least one user, who satisfy the criteria requested by user A in step 103. The corresponding users P are marked in a database as well as in the local memory of the computing device.

From there, in step 105, the users P are contacted electronically either through e-mail, messaging, instant messaging, or other internet communication means, and are sent a message M. The content of the message M sent to those users includes a link to user A's profile, as well as information about the kind of feedback that user A is looking for, as outlined in step 103. The content of the message is generated automatically using the computing device in tandem with the website database.

As outlined in step 106, when message M is received by the users in P, some of them will proceed to open the provided link and read the kind of review that the user is asking for. From there, the website will expose a form which allows users in P to enter critiques about user A's profile. When a user in P is done reading the profile and writing his critique about it into the form website, the critique will be sent back through the internet and stored in the website database, along with any other information that may be useful in identifying who user A is, as well as who the reviewer is.

Finally, as users in P submit their reviews, the data is aggregated as shown in step 107. The aggregation is done by the computing unit on the website server. In the simplest embodiment, the data is just displayed to the user in the same way as it was stored: in particular, website W displays the name of the reviewers and their comments about the profile and corresponding ratings, if any. It is also possible to display average ratings of all the users in P, or ratings sliced by age range, gender or other categories to the user. The way this information is displayed does not greatly impact the overall flow of the present invention.

The overall advantages of this method are that: user A is able to get feedback from users who have either more experience or are better suited than A, user A is then able to refine his profile to satisfy those reviews, making user A's profile more attractive or valuable to the set of people he was originally interested in targeting.

In the context of professional business networking for example, let's say user A has recently graduated college and has only two years of work experience. User A puts up his profile on a resume website but is unable to get any interest from companies. He can then request feedback from the existing users on the site, perhaps focusing on people in his field of work that have more than 10 years of experience, or even on recruiters who will be able to give him valuable feedback as to the kinds of changes he would have to make to his profile to get it to be more attractive to prospective employers.

In the context of online dating for example, let's say user A is trying to find a romantic partner on website W. User A posts his profile but after being seen a few times, receives little to no interest. User A can then submit his profile for review by other, more experienced users on website W who can give him more feedback about how to improve his profile. User A could just go as far as opening his profile for review to people of the gender he is attracted to and within the age range that he is interested in, so that he can better understand why his target audience is not interacting with his profile.

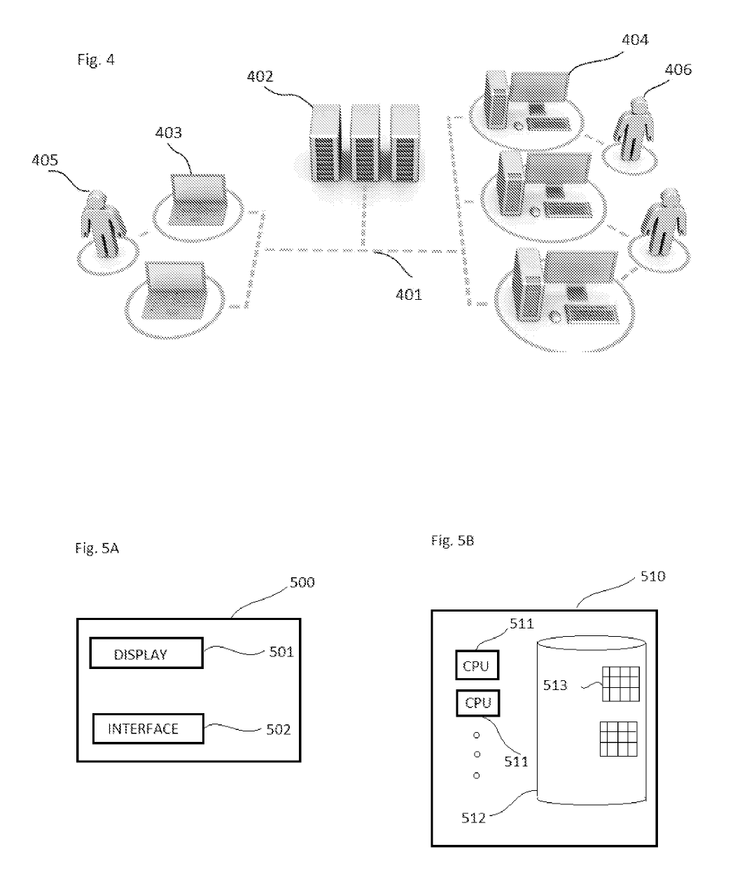

FIG. 4 shows a bit more information pertaining to the hardware involved. Such hardware is currently widespread and well understood and we are bringing it up for the sake of completeness. The method above is meant to run on a computing device such as a computer, server, phone, terminal or other devices. Users such as 405 and 406, through the use of their computing devices or terminals 403 and 404 respectively use the network or internet 401 to connect to one or more servers 402. 401 here could be the currently in-use internet, or a local area network, or a plain telephone system, or a wide area network. For a terminal to connect to the network they can use wired or wireless mediums which may be provisioned with routers and firewalls, but not limited to the above.

An example scenario with this architecture would be that user 405 through his use of computing device 403, connects to the server 402 and interfaces with his device to request feedback from the server. The device in turn relays information over the network 401 and such information is stored on the database of the server. The server then notifies the computing devices of matching users that it found in its database, typically through e-mail or instant messaging. If in this case, 406 is such a matching user, a notification will be available on his computing device 404 via one of the electronic messaging means described above. 406, through the user of his computing device will then be able to read the profile of user 405 and enter feedback about said profile into his terminal. Once 406 is done writing his feedback, he would submit it electronically through the use of the terminal, and that review would be sent over the internet back to server 402. At that point, user 405 would be notified by said server that a review for his profile is available, and would be able to view said review using his terminal.

FIG. 5A is a diagram showing one embodiment of the terminal used by users. In this embodiment, the terminal 500 comprises a display system 501 as well as an interface 502 that allows its users to interact with it.

FIG. 5B is a diagram showing one embodiment of the server to which the terminals are connecting. The server 510 contains one or more processing units 511, as well as memory 512, which may be made up of one or more databases 513.

The above described the preferred embodiment, but there are several alternate embodiments which are described hereafter.

### Alternative Embodiments

We believe there are several ways to implement the overall system described above. The common factors are that a user on website W wants a simplified way to get verbal or numeric feedback about his profile by other users of website W.

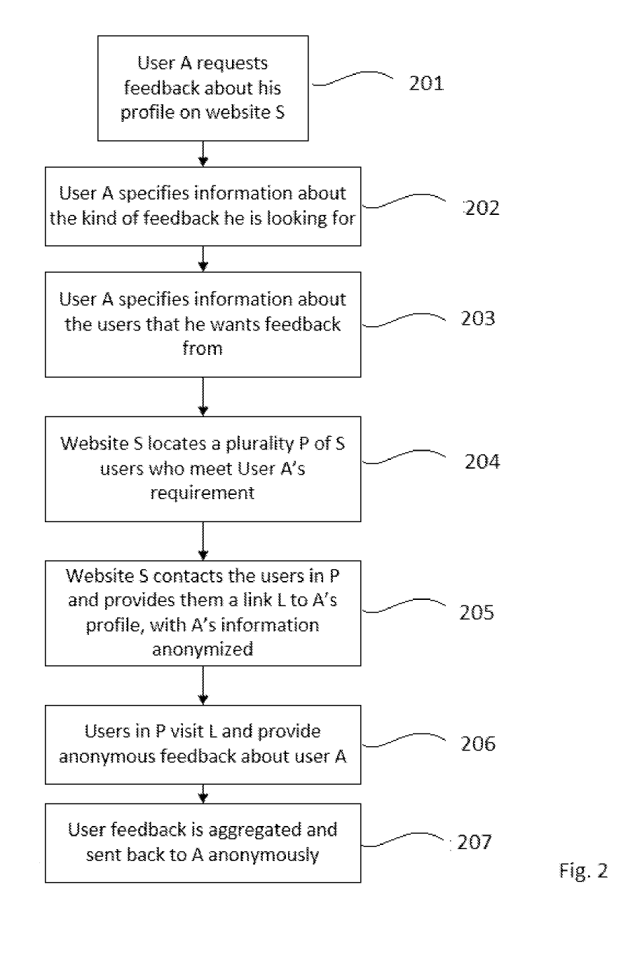

One such embodiment is described in FIG. 2. In this embodiment, special care is taken to keep the identity of user U and the identity of the reviewer users in P anonymous, so that the reviews are unbiased. While this embodiment requests both user U and users in P to be anonymous, it is possible to restrict it so that only user U is anonymous with users U being known, or have user U be anonymous with the reviewers known.

The embodiment is similar to the main embodiment and most of the details can be found in the preceding description. In 201, user A, through the website W, clicks on a link that requests feedback about his profile. The information is stored in the web server database. At this point, the user may optionally specify whether he'd like his information to be anonymized or public—if he chooses anonymous, then private information such as the name and location may be removed from the profile displayed to the reviewers.

In 202, 203, 204 of FIG. 2, as in 102, 103 and 104 of FIG. 1 correspondingly, the user specifies the kind of feedback that he is looking to get from his reviewers, as well as the kind of reviewers that he is looking for feedback from. The details of this operation are described in the main embodiment.

In 205, the website strips out any personal profile information from user U's profile before sending it out to the reviewers P, as was done in 105. Removing personal profile information here is understood to mean: hiding the user name, user ID, user IP address, physical location and date of birth, as well as other parts of the profile which may otherwise compromise anonymity. As such, for example, instead of displaying the full profile of P to the reviewers, the name will be missing and perhaps some of the pictures.

In 206 and 207, which are similar to 106 and 107 of FIG. 1, any feedback which is left by the reviewers is also anonymized, so that user U is only aware of what the feedback is, but not who made it. The purpose of this embodiment is to make it easier for reviewers to give candid feedback to user U without having to worry about their identity being compromised.

For example, on an online dating site T, if user A is male, he may request anonymous feedback from women on T and user A would never know who the women who reviewed him were. This would serve to protect both user A and the reviewers' identities and privacy.

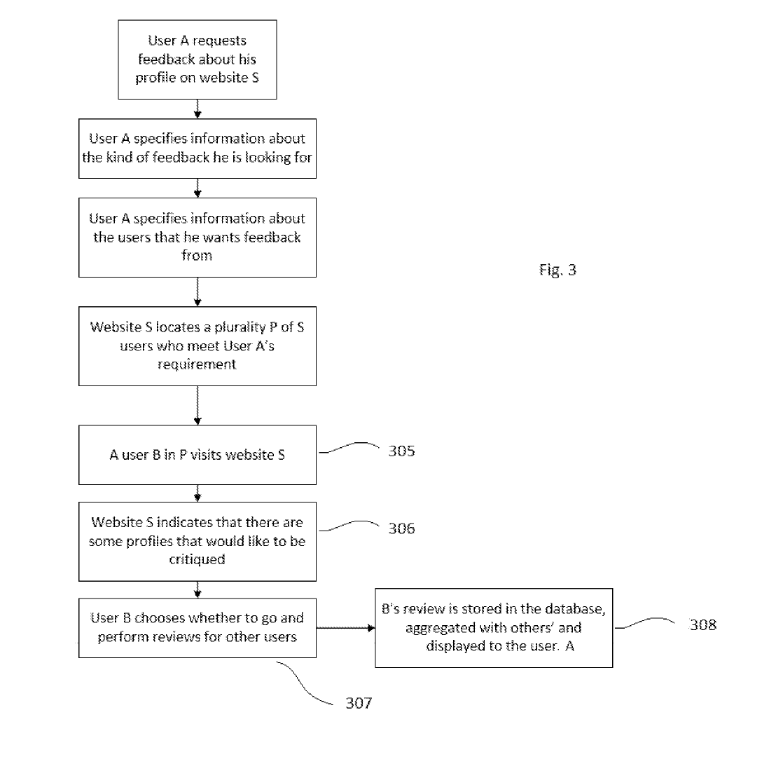

Another embodiment is described in FIG. 3. In this case, the reviewers are not directly notified that a review is pending via messaging. Instead, the notification may show up when they are visiting the site W, and they are made aware that a certain number of users have requested reviews and that may choose to give them feedback.

The difference between this embodiment and the first embodiment starts at step 305. A user B who meets the criteria requested by the user A request happens to be visiting the site. At that point, as outlined in 306, a notification in the form of an image or text appears on the main website W to user B, notifying him that there are users whose profiles need to be critiqued. If there are many such profiles, they are typically either ordered by submission date, or in a random order so as to diversify the reviews. In another embodiment, no such notification is displayed, and user B must explicitly choose to go look for users who want their profiles reviewed.

At that point, user B can choose whether to do a review as shown in 307, and if he does, then that review is stored in the database and aggregated, similar to the first embodiment.

There are several other embodiments possible for this—they are not limited to the following list and one can possible imagine combinations of the following to form valid embodiments as well.

In one embodiment, users may be able to opt out of receiving review requests. This would be done by a form on the website and would be stored in the website database. The review system of embodiment 1 would then check the database to see which users had opted out of doing reviews and would not notify them or allow them to complete said review.

In another embodiment, the review may be subject to a minimum distance requirement—that means that for preserving personal information even further, a user may not be allowed to review another user's profile unless they are more than a certain distance away. We'll use the terminology “geographically distant” to refer to users who are more than a pre-determined distance away from each other. For example, in online dating and for safety and privacy reason, this embodiment would allow reviews of people who are at least 100 miles away. This would be done by checking the database for the location of the user and of the potential reviewer by the computing unit, calculating the distance, and making a determination as to whether they are far enough from each other to authorize a review. The 100 miles example above should not be considered to be specific, and different applications can provide different distances—a web site with a high privacy risk might want to specify a 200 mile minimum distance, whereas a website with low-privacy risk could settle for a 10 mile minimum distance.

In another embodiment, reviewers may be rewarded for submitting their review about another user, or they can be rewarded if the user deems their review to be above a certain threshold. For example, a critiqued user might have the option of selecting whether the review was useful, or to grade it on a scale from one to five, and those would serve as thresholds. Such rewards may be purely virtual, such as points in the website, or they may be monetary. For example of a virtual reward, people who have done the most number of useful reviews may get a higher ranking in web searches or higher profile placements, or may even redeem the points to get gifts or free subscription months. By useful reviews here we mean a review that was submitted to user A that user A later accepted as being useful through the website. The review reward could be monetary with user A offering money to website S and website S distributing this money to reviewers while potentially keeping a commission.

### CONCLUSIONS, RAMIFICATIONS AND SCOPE

Thus the reader will see that at least one embodiment of the critique system described above will allow users to easily get valuable feedback about their feedback from people who are well suited to give such feedback.

While the above description contains many specificities, these should not be construed as limitations on the scope but rather as an exemplification of one or several embodiments thereof. Many other variations are possible. For example, it may be possible for the reviews to be hosted on a separate website—i.e. for a profile on website W, website R can be used to request reviews.

Accordingly, the scope should be determined not by the embodiments illustrated, but by the appended claims and their legal equivalents.

What is claimed is:

1. A computer-implemented method comprising:
receiving a plurality of user profiles, each user profile comprising characteristics of a respective user;
receiving a request requesting profile critiques, said request being associated with a first user;
notifying a plurality of different users about said request;
exposing information about first user's profile to said different users;
receiving a plurality of user critiques from said different users about first user's profile;
notifying and providing said first user with said plurality of user critiques.

2. The method of claim 1, wherein the notifying steps are done through the use of electronic mail.

3. The method of claim 1, wherein said plurality of notified different users are geographically distant from said first user's location.

4. The method of claim 1, further comprising:
rewarding said plurality of different users based on critique quality.

5. The method of claim 1, further comprising:
anonymizing said first user by hiding said first user's personal profile information from said different users.

6. The method of claim 1, further comprising:
anonymizing said plurality of different users by hiding said different users' personal information from said first user.

7. The method of claim 1, further comprising:
allowing said first users to permanently opt out of providing critiques.

8. A computer-implemented method comprising:
receiving a request requesting profile critiques, said request being associated with a first user;
receiving a request to do a profile critique, said request being associated with a second user;
revealing said first user's profile information to said second user;
receiving a critique of said first user's profile, by said second user;
displaying said critique to said first user.

9. The method of claim 8, wherein the step of revealing is done only if said first user and said second user are geographically distant.

10. The method of claim 8, further comprising:
prompting said first user to grade said critique;
rewarding said second user if said grade is above a threshold.

11. The method of claim 8, further comprising
anonymizing said first user's profile information before revealing it to said second user, by removing said first user's personal information.

12. The method of claim 8, further comprising:
Anonymizing said second user's profile information before revealing said critique to said first user, by removing said second's user personal information.

13. A non-transitory computer-readable medium comprising instructions that, when executed by as processor with memory, are configured to at least:
receive a request requesting profile critiques, said request being associated with a first user,
store said request in said memory,
notify a plurality of users about said request,
display said first user's profile to said plurality of users,
receive a plurality of user critiques from said plurality of different users, and
provide said first user with said plurality of user critiques.

14. The medium of claim 13, where the instructions are further configured to:
anonymize said first user's profile by removing personal information.

15. The medium of claim 13, where the instructions are further configured to:
anonymize said plurality of user critiques.

16. The medium of claim 13, where the instructions are further configured to:
verify said plurality of users is geographically distant from said first user.

17. The medium of claim 13, where the instructions are further configured to:
provide a reward said plurality of users.

18. The medium of claim 13, wherein notifying the plurality of users gets done by electronic mail.
